(19) United States
(12) Patent Application Publication
(10) Pub. No.: US 2024/0044315 A1
(43) Pub. Date: Feb. 8, 2024

(54) Potential Energy Translation to Rotational Acceleration Mechanism

(71) Applicant: Patrick Holt, Harvard, IL (US)

(72) Inventor: Patrick Holt, Harvard, IL (US)

(73) Assignee: Patrick A Holt, Harvard, IL (US)

(21) Appl. No.: 17/879,239

(22) Filed: Aug. 2, 2022

(51) Int. Cl. F03G 3/00

(52) U.S. Cl. CPC F03G 3/094

(57) ABSTRACT

A improved mechanism to create rotational mechanical advantage from an acceleration field while eliminating reactant gyroscopic force, consisting of a tower mount assembly (10) rotationally connected to a gimbal assembly (20). A conic counterweight arm assembly (30) rigidly attached to the crown plate (28) of the gimbal assembly (20). A powered action arm assembly (37) rotationally connected in a horizontal plane to the crown plate shaft (29) of the gimbal assembly (20) and rotationally contacts the conic counterweight arm assembly (30) via a wheel and track. A gravity arm assembly (55) rotationally connected in a horizontal plane, adjacent to the first arm assembly, to the gimbal assembly (20) and rotationally contacts the conic counterweight arm assembly (30) via a wheel and track. A main shaft assembly (65) rotationally connected via a flexible shaft coupler (67) thru the center of the gimbal assembly (20) to the gravity arm assembly (55) A main shaft assembly (65) rotationally connected at the opposite end to a transmission assembly (72). A transmission assembly (72) located along the tower mount assembly (10) rotationally connected to a rotary power generating device (80) rigidly connected to the tower mount assembly (10) via a attachment mounting assembly (77). An electrical control assembly (83) to controllably power the action arm assembly. The tower mount assembly mounts a rotary power generating device in a stationary position thus eliminating reactant gyroscopic force. The gimbal assembly is connected to the top of the tower mount assembly. The gravity arm and action arm assemblies are balanced about the gimbal assembly by the conic counterweight arm assembly shaped in a conic array of weighted arms. The powered action arm assembly rotates about the axis of the gravity arm assembly, creating an imbalance in the gimbal assembly, causing the gravity arm assembly to rotate, and the conic counterweight arm assembly to swing, all in the same direction of the action arm assembly. The main shaft assembly receives torque from the gravity arm assembly transmitted down the main shaft assembly thru the gimbal assembly via a flexible shaft coupler to the transmission assembly. The transmission assembly rotates the stationary mounted rotary powered device connected to the tower mount assembly.

### BACKGROUND—FIELD OF INVENTION

The field of this invention relates to motors and more particularly to a motor which receives as input the force of gravity.

### Background—Description of Prior Art

In the prior art, U.S. Pat. No. 9,689,379, shows a mechanism that consists of two separate arms of differing lengths and masses, that are rotationally attached to a gimbal assembly. These arms are known as the action arm assembly, and the gravity arm assembly. A third arm is set perpendicular and below to the other two arms and is rigidly attached to the gimbal assembly. This arm is known as the counterweight arm assembly. The gimbal assembly is rotationally attached to a mount assembly that supports the mechanism and allows proper motion of the gimbal assembly and thus the proper motions of each arm assembly.

In the prior art, the gravity arm assembly is connected, via a series of shafts and transmission gears, to the rotary power generating device located along the long axis of the counterweight arm assembly. The counterweight arm assembly swings under the gimbal assembly in response to the radial positions of the other two arms. Thus the rotary power generating device swings around in the same motion as the counterweight arm assembly. This configuration however, allows the gyroscopic forces within the rotary power generating device, to be subject to a constantly changing gravitational force vector that can create unwanted perturbations in the overall motion of the Potential Energy Translation to Rotational Acceleration Mechanism, thus affecting the performance of the mechanism. No means for alleviation of these unwanted motions and forces is provided for in U.S. Pat. No. 9,689,379.

It is also important to note, that the higher the angular speed of the rotary power generating device, the more gyroscopic force is generated by the rotating components.

This translates into increased perturbations in the movements of the mechanism and a loss of efficiency. This also limits the rotational speed of the rotary power generating device to lower angular speeds to avoid buildup of gyroscopic force.

What is needed to alleviate these forces is to mount the rotary power generating device so it is stationary. The Potential Energy Translation to Rotational Acceleration Mechanism, however, must be allow to move in its normal motions while transferring the torque generated by the gravity arm assembly to the now stationary rotary power generating device.

This is accomplished via several improvements over the prior art. The rotary power generating device is mounted to a new tower mount assembly, underneath the rotational center of the gimbal assembly thus allowing for the stationary mount of the rotary power generating device and proper support of the mechanism.

An improved conical shaped counterweight arm assembly is necessary due to the new location of the tower mount and now stationary rotary power generating device. In the prior art, a single leg counterweight arm cannot move properly with the new position of the tower mount and stationary rotary power generating device.

An improved gimbal assembly is necessary to locate a flexible shaft coupler as close to the center of rotation of the gimbal assembly as possible, while still providing support for the gravity and action arm assemblies. Also the inner gimbal plate attaches rotationally to the tower mount whereas the outer gimbal plate attaches to the mount in the prior art. This allows for improvements to the arm assemblies, improved range of motion for the gimbal assembly and proper clearance for the shaft assembly.

A improvement in the overall shape of the gravity arm and action arm assemblies and the addition of support wheels at the arm ends, will allow for the use of heavier arm weights while reducing unwanted torsional shear at the arm hubs. Support wheels at the end of both arm assemblies run along circular tracks mounted to the conic counter weight assembly. These arm changes can further reduce the size of the device while increasing output and improve operation.

### Objects and Advantages

Accordingly, several objects and advantages of the invention are:
(a) to provide a means to alleviate the conflict of gyroscopic forces reacting to the constantly changing gravitational force vector created by locating a spinning rotary power generating device along the moving counterweight arm axis of a Potential Energy Translation to Rotational Acceleration Mechanism.
(b) to provide a means to increase the angular speed of the rotary power generating device while not creating conflicting forces and reducing efficiency.
(c) to provide a means for the implementation of a vertical tower-type mount structure by allowing the use of a conical-shaped counterweight arm assembly that creates a void area that would otherwise be occupied by a standard counterweight arm assembly, while also reducing the overall length of the counterweight arm thus reducing overall size of the mechanism.
(d) Allows for a simplified, stationary, wiring assembly when using a generator/alternator as the rotary power device, without the need for flexible wiring connections or rotational wiring connections, or flexible fluid lines or rotating fluid connections, in the case of a fluid pump as a rotary power generating device.
(e) The use of a conical-shaped counterweight arm assembly allows the use of alternate gravity arm and action arm assemblies that can further reduce the size of the device and improve operation.
(f) Increases the operating weight of the arm assemblies while reducing the torsional stress applied to the action arm and gravity arm hub assemblies.
(g) Allows the use of gravity and action arm assemblies that conform to or near the angle of the conic counterweight and have wheel assemblies that run along tracks attached to the conic counterweight arm assembly to reduce torsional stress on the arm hub assemblies and allow for the use of increased arm weights.

Further objects and advantages are to provide a means to reduce the overall footprint of the device with relation to floor or ground space due to the use of the more compact tower mount assembly. Still further objects and advantages will become apparent from a consideration of the ensuing description and drawings.

### DRAWING FIGURES

FIG. 1 is a detailed view of Tower Mount Assembly

FIG. 2 is a detailed view of Gimbal Assembly

FIG. 3 is a detailed view of Conic Counterweight Assembly

FIG. 4 is a detailed view of Action Arm Assembly

FIG. 5 is a detailed view of Gravity Arm Assembly

FIG. 6 is a detailed view of Transmission/Attachment Mounting/Electrical Assemblies

FIG. 7 is a detailed view of Improved Mechanism with associated assemblies

FIG. 8 is a close up view of Gimbal Assembly showing flexible shaft coupling

FIG. 9 is a close up view showing stationary mount of Rotary Power Generating Devices

FIG. 10 is a simplified schematic of Electrical Control Assembly

FIG. 11 is a view of Conic Counterweight Assembly with Ring-shaped Counterweight

### SUMMARY

In accordance with the present invention, a improved mechanism to create rotational mechanical advantage from an acceleration field while eliminating reactant gyroscopic force, consisting of a tower mount assembly rotationally connected to a gimbal assembly, a conic counterweight arm assembly rigidly connected vertically to a gimbal assembly. In balance with, a horizontally mounted, rotationally connected, powered action arm assembly, rotationally contacting a conic counterweight arm via a wheel and a track, and a horizontally mounted, rotationally connected, gravity arm assembly, rotationally contacting a conic counterweight arm via a wheel and a track, and rotationally coupled to a main shaft assembly via a flexible main shaft coupler. Main shaft assembly is rotationally connected to a transmission assembly that is rotationally connected to a stationary mounted rotary power generating device, mounted via a attachment mounting assembly. Mechanism is controlled by a electrical control assembly.

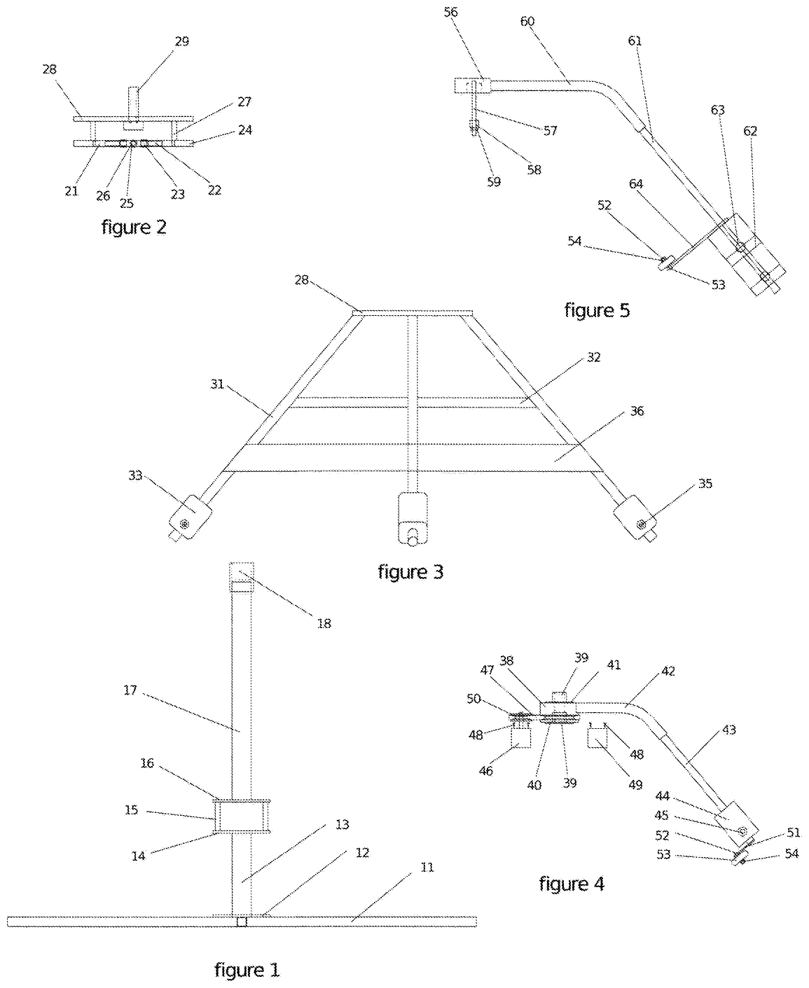

### Description—FIGS. 1 to 11

A typical embodiment of the mechanism of the present invention consists of a Tower Mount Assembly 10, a Gimbal Assembly 20, a Conic Counterweight Arm Assembly 30, a Action Arm Assembly 37, a Gravity Arm Assembly 55, a Main Shaft Assembly 65, a Transmission Assembly 72, a Attachment Mounting Assembly 77, a Electrical Control Assembly 83. Shown in FIG. 7.

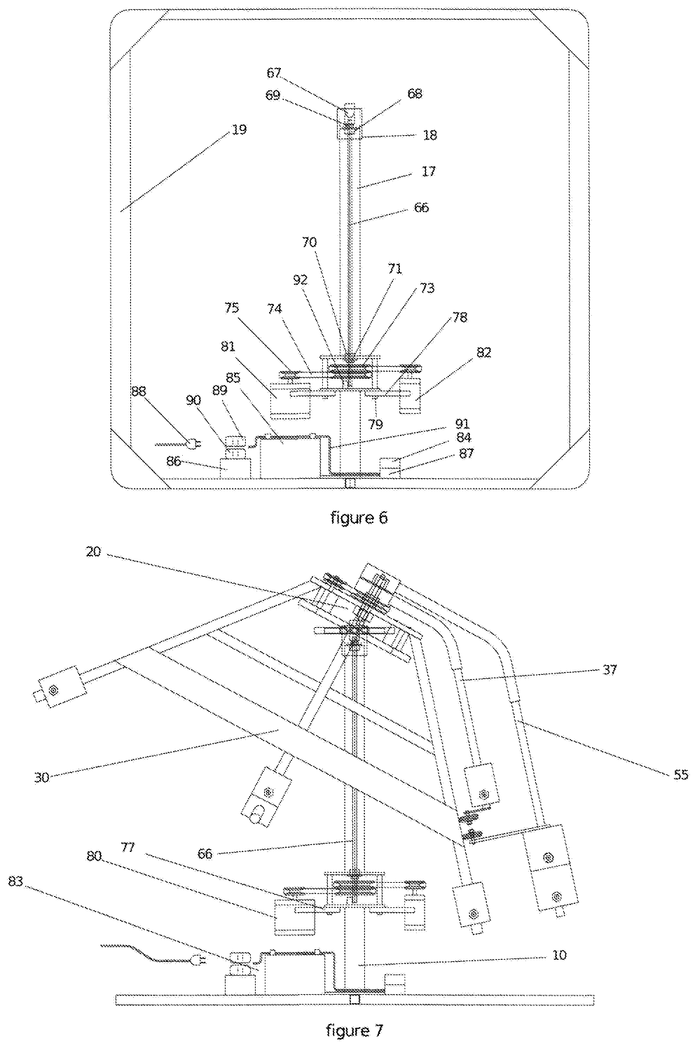

A Tower Mount Assembly 10 consists of a series of Base Legs 11, a Base Center Hub 12, a Lower Mount Mast 13, a Lower Divide Plate 14, a series of Mast Divide Posts 15, a Upper Divide Plate 16, a Upper Mount Mast 17, a Mast Collar 18, a Stack Frame 19. Shown in FIG. 1 and FIG. 6.

A Base Leg 11 consists of square carbon steel tubing or other suitable material, of a predetermined shape, length, size and thickness. The Base Center Hub 12 is a square shaped, or other suitable shape, plate of carbon steel or other suitable material, of a predetermined thickness, with a square dimension of approximately one quarter of the length of the Base Leg 11. A hole is located at the center of the Base Center Hub 12 of a suitable diameter to allow access to interior of Lower Mount Mast 13. A series of four Base Legs 11 is attached horizontally to a Base Center Hub 12 using welded connection or other suitable means, so as each Base Leg 11 is 90 degrees to each other, and meet each other near the center of the Base Center Hub 12. The opposite ends of the Base Legs 11 are attached via welded or other suitable means, to a Stacking Frame 19. Shown in FIG. 6. A Stacking Frame 19 is a outer box frame of a cubic or other suitable shape with predetermined dimensions, constructed of square tubular carbon steel or other suitable material, and surrounds the entire mechanism.

A Lower Mount Mast 13 constructed of tubular carbon steel or other suitable material, of a suitable diameter, thickness, and a length of approximately one quarter the total height of the Tower Mount Assembly 10, is vertically attached to the center of the Base Center Hub 12 via welded or other suitable connections, at the center of the Base Center Hub 12 on the side opposite the Base Legs 11. A Lower Divide Plate 14 is a square plate of carbon steel or other suitable material, with a predetermined thickness, and a square dimension equal to at least two inches larger than the diameter of the Lower Mount Mast 13. A hole is located at the center of the Lower Divide Plate 14 of a suitable diameter to allow access to interior of Lower Mount Mast 13. The Lower Divide Plate 14 is centered and attached to the opposite end of the Lower Mount Mast 13, from the Base Center Hub 12, via welds or other suitable means. A Upper Divide Plate 16 is Identical to the Lower Divide Plate 14, except a center hole is of a size to accept a Lower Shaft Bearing 70, and is attached to a Upper Mount Mast 17, similar to the connection between the Lower Mount Mast 13 and the Lower Divide Plate 14. The Upper Mount Mast 17 is identical to the Lower Mount Mast 13, except the length is approximately five eighths the total height of the Tower Mount Assembly 10. The Upper Divide Plate 16 and the Lower Divide plate 14 are connected via a series of four Mast Divide Posts 15. A Mast Divide Post 15 is a carbon steel rod or other form, of a predetermined length and diameter, and attach via welded or other suitable connections, thus forming an open gap in the Tower Mount Assembly 10. Shown in FIG. 1.

A Mast Collar 18 consisting of tube shaped carbon steel collar, or other suitable material, of a diameter to accept the Upper Mount Mast 17 inside the tube, of a predetermined thickness, with appropriate connection holes, 180 degrees from one another, inset into collar sides near one end to accept a Inner Gimbal Bearing 23 of a Gimbal Assembly 20. A plate is welded perpendicular to the interior of the Mast Collar 18 a predetermined distance from the end opposite the connection holes. A hole is cut into the plate at its center to accept a Upper Shaft Bearing 68 and thus the Main Shaft Assembly 65. The Mast Collar 18 is attached to the upper end of the Upper Mount Mast 17 via welded or other suitable connections. Shown in FIG. 7 and FIG. 8.

A Gimbal Mount Assembly 20 consists of a Inner Gimbal Plate 21, a series of Inner Gimbal Shafts 22, a series of Inner Gimbal Bearings 23, a Outer Gimbal Plate 24, a series of Outer Gimbal Shafts 25, a series of Outer Gimbal Bearings 26, a series of Outer to Crown Posts 27, a Crown Plate 28, a Crown Plate Shaft 29. Shown in FIG. 2 and in FIG. 8.

A Inner Gimbal Plate 21 is a flat, ring shaped plate, or other suitable shape, with a predetermined outer diameter, inner diameter, and thickness, constructed of carbon steel, or other suitable material. Inner Gimbal Plate 21 has a center hole of predetermined diameter, a series of four slots of predetermined length and width, set 90 degrees apart, two cut perpendicular to the inner radius, extending approximately half the distance between inner and outer radii, and set 180 apart, and two slots cut perpendicular to the outer radius extending approximately half the distance between inner and outer radii, and set 180 apart, and 90 degrees from the inner radius slots. A series of two Inner Gimbal Shaft 22 consist of a straight, round shaft of a predetermined length and diameter, constructed of a suitable high-strength material such as a steel alloy, insert and align with inner radius slots in Inner Gimbal Plate 21, and connect via a welded or other suitable connection. A series of two Outer Gimbal Shaft 25 consist of a straight, round shaft of a predetermined length and diameter, constructed of a suitable high-strength material such as a steel alloy, insert and align with outer radius slots in Inner Gimbal Plate 21, and connect via a welded or other suitable connection. A series of two Inner Gimbal Bearings 23 are inset in the connection holes found in the Mast Collar 18, 180 degrees from one another, to accept the Inner Gimbal Shaft 22, and thus the Inner Gimbal Plate 21.

A Outer Gimbal Plate 24 is a flat, ring shaped plate or other suitable shape, with an inner radius larger than the outer radius of a Inner Gimbal Plate 21, and outer radius of a predetermined diameter, having a predetermined thickness, and constructed of carbon steel, or other suitable material. A series of smaller holes of predetermined diameter are set at regular intervals within a set distance near the outer radius. A series of two slots of predetermined length and width, set 180 degrees apart, are cut perpendicular to the inner radius, extending approximately half the distance between inner and outer radii. A series of two Outer Gimbal Bearings 25, consist of a commercially available needle bearing, or other suitable bearing type, are inset into the two slots found in the inner radius of the Outer Gimbal Plate 24, and attached via welded connection or other suitable means, to accept a series of two Outer Gimbal Shafts 25, and thus rotationally connect the Outer Gimbal Plate 24 to the Inner Gimbal Plate 21. Shown in FIG. 2 and FIG. 8.

A Crown Plate 28 is a flat, round plate, or other suitable shape, with a predetermined diameter, constructed of carbon steel, or other suitable material. Crown Plate 28 has a center hole the diameter of a predetermined radius, to accept a Crown Plate Shaft 29, and a series of smaller holes of predetermined diameter set at regular intervals within a set distance near the outer radius, in the same pattern as found on Outer Gimbal Plate 24. Set vertically into the center hole of the Crown Plate 28 via welded or other suitable connections, is a Crown Plate Shaft 29 consisting of a hollow carbon steel shaft, or other suitable material, with a center bore of a predetermined diameter to accept a Gravity Arm Shaft Bearing 56. Shown in FIG. 2 and FIG. 7.

The Crown Plate 28 is connected to the Outer Gimbal Plate 24 via a series of four Outer to Crown Posts 27. A Outer to Crown Post 27 is a carbon steel rod or other form, of a predetermined length and diameter, and attach via welded or other suitable connections, at the holes located in the Crown Plate 28 and the Outer Gimbal Plate 24. Shown in FIG. 2.

A Conic Counterweight Arm Assembly 30 consists of a series of Counterweight Arms 31, a Counterweight Arm Support 32, a series of Counterweights 33, or a Ring-Shaped Counterweight 34, a series of Counterweight Stay Bolts 35, a Torsion Wheel Track 36. Shown in FIG. 3 and FIG. 11.

A Counterweight Arm 31 is a carbon steel tube or other suitable material and form, of a predetermined diameter, wall thickness and length. A series of four Counterweight Arms 31 attach via welds or other suitable connection, to the Crown Plate 28 downward at a predetermined angle attaching to the Crown Plate 28 at 90 degree intervals, so as to create a conic shape. A Counterweight Arm Support 32 is a curved band of steel or other suitable material and shape, connected between one Counterweight Arm 31 to the next, with welds or other acceptable means of connection. The Counterweight Arm Support 32 is located at a predetermined distance along the length of the Counterweight Arms 31. Attached to the Ends of the Counterweight Arms 31, is a series of four Counterweights 33 constructed of a suitable dense material such as cast iron, with a predetermined mass, and have a cylindrical or other suitable shape. The Counterweight 33 is secured to the Counterweight Arm 31 via a Counterweight Stay Bolt 35 passing thru a hole, of predetermined diameter and position, located laterally thru the Counterweight 33, and a hole located near the end of the Counterweight Arm 31 at a predetermined distance. An alternate to the individual Counterweight 33 series, is a Ring Shaped Counterweight 34 that has a ring shape and is constructed with a suitable dense material and dimensions, to equal the total mass of Counterweight 33 series and connect to each Counterweight Arm 31 via the end holes and secured by a Counterweight Stay Bolt 35. Shown in FIG. 3 and FIG. 11.

A Action Arm Assembly 37, consists of a Action Arm Hub 38, a Inner Hub Bearing 39, a Lower Ring Bearing 40, a Upper Ring Bearing 41, a Action Arm Arch 42, a Action Arm 43, a Action Arm Weight 44, a Action Arm Weight Stay Bolt 45, a Drive Motor 46, a Drive Belt 47, a series of Drive Motor Mount Bolts 48, a Drive Motor Counterweight 49 a Drive Motor Pulley 50, a Action Arm Torsion Wheel Mount Plate 51, a Torsion Wheel Axle 52, a Torsion Wheel 53, a Shaft Collar 54. Shown in FIG. 4.

A Action Arm Hub 38 is a cylindrical shaped component of a predetermined diameter, machined from carbon steel or other suitable material, with a center bore of a predetermined diameter, running thru the vertical center axis to accept a Inner Hub Bearing 39, that in turn, accepts the Crown Plate Shaft 29. A Inner Hub Bearing 39 is a commercially available Needle type Bearing of predetermined dimensions and is set within the center bore. A flat surface is cut into the upper half of the cylindrical shaped component, at predetermined lengths and depths, forming a D-shaped cross section when view from the top.

A groove is cut into the top of the Action Arm Hub 38 between the flat surface and surrounding the center hole, to accept a Upper Ring Bearing 41. A Upper Ring Bearing 41 is a commercially available thrust type bearing of acceptable dimensions, that sandwiches between the Action Arm Hub 38 and the Gravity Arm Hub 56.

The Lower end of the Action Arm Hub 38 is flat with a circular groove cut into to the surface surrounding the center bore at a predetermined depth, to accept a Lower Ring Bearing 40. A Lower Ring Bearing 40 is a commercially available thrust type bearing that sandwiches between the Action Arm Hub 38 and the Crown Plate 28 located underneath. Shown in FIG. 4.

Centered on the lower half of the Action Arm Hub 38 is a groove cut circumferential into the diameter of the component, at a predetermined depth, width, and cross section, to accept a Drive Belt 47. A Drive Belt 47 is a commercially available belt made of rubber or suitable material with a suitable length and cross section. A Drive Motor 46 consists of a commercially available electric motor of a suitable type, size and power to rotate the Action Arm Assembly 37. The Drive Motor 46 is mounted to the Crown Plate 28 via mount pattern cut into the Crown Plate 28 at a suitable location, to accept the mounting pattern of the Drive Motor 46 and is secured by a series of Drive Motor Mount Bolts 48, or other suitable means. A Drive Motor Pulley 50 is a commercially available pulley of suitable dimensions, that is mounted on the shaft of the Drive Motor 46, and accepts the Drive Belt 47.

A Drive Motor Counterweight 49 is a counterweight made of suitable material and dimensions, of the same mass of the Drive Motor 46 and is mounted directly across the center of the Crown Plate 28 from the Drive Motor 46 at a suitable distance to balance the mechanism. Shown in FIG. 4.

A Action Arm Arch 42 is an arch shaped structure, such as a tube or rod of predetermined diameter, bent in the shape of an arch or other suitable shape, of a predetermined height and width, having two straight ends of predetermined length. One end is attached to the flat surface on the Action Arm Hub 38 via welded connection or other acceptable means. The Action Arm Arch 42 is formed to an approximate angle equal to that of the Counterweight Arms 31. The Action Arm Arch 42 is connected to a Action Arm 43, via a welded or other suitable connection. A Action Arm 43 is a straight rod or tube of a predetermined length and diameter, extending thru the center bore of a Action Arm Weight 44 and is secured by a Action Arm Stay Bolt 45 via a lateral hole in both the Action Arm Weight 44 and the Action Arm 43 at an appropriate location. A Action Arm Weight 44 is a weight of a predetermined mass, of a cylindrical shape or other suitable shape, and has a center bore spanning the longitudinal axis, constructed of high-density material such as cast iron or any other suitable material. A Action Arm Weight 44 is typically of a smaller mass than a Gravity Arm Weight 62, approximately between 25% and 75% of the mass of a Gravity Arm Weight 62. Shown in FIG. 4 and FIG. 7.

Attached to the end of the Action Arm 43 is a Action Arm Torsion Wheel Mount Plate 51. The Action Arm Torsion Wheel Mount Plate 51 is a rectangular carbon steel plate of a predetermined thickness and dimension, attached via welds or other suitable means, perpendicular to the end of the Action Arm 43, extending lengthwise towards the Conic Counterweight Arm Assembly 30. A hole is cut into the Action Arm Torsion Wheel Mount Plate 51 at a appropriate location to accept a Torsion Wheel Axle 52. A Torsion Wheel Axle 52 is a short shaft of a predetermined length and diameter. A Torsion Wheel 53 is mounted on the Torsion Wheel Axle 52 and secured with a standard Shaft Collar 54. The Torsion Wheel 53 sets on and runs along a Torsion Wheel Track 36. A Torsion Wheel Track 36 is a circular band of suitable size and material, that is attached to the Counterweight Arms 31 via welds or other means, and forms a circular track around the circumference of the Conic Counterweight Arm Assembly 30. shown in FIG. 4 an FIG. 7.

A Gravity Arm Assembly 55 consists of a Gravity Arm Hub 56, a Inner Hub Bearing 39, a Gravity Arm Shaft 57, a Gravity Arm Shaft Bearing 58, a Gravity Arm Shaft Collar 59, a Gravity Arm Arch 60, Gravity Arm 61, a Gravity Arm Weight 62, a Gravity Weight Stay Bolt 63, a Gravity Arm Torsion Wheel Mount Plate 64, a Torsion Wheel Axle 52, a Torsion Wheel 53, a Shaft Collar 54. Shown in FIG. 5.

A Gravity Arm Hub 56 is a cylindrical shaped component of a predetermined height and diameter, machined from carbon steel or other suitable material, having a flat surface cut into the upper half of the overall height, at a predetermined length and depth, forming a D-shaped cross section when view from the top, with a center bore of a predetermined radius, cut approximately three quarters the total height thru the vertical center axis to accept a Inner Hub Bearing 39, that in turn, accepts the Crown Plate Shaft 29. The upper quarter of the Gravity Arm Hub 56 has a smaller center bore of a predetermined radius, cut thru the vertical center axis to accept a Gravity Arm Shaft 57. A Gravity Arm Shaft 57 is a rod that extends downward from the Gravity Arm Hub 56 thru the center of the Crown Plate Shaft 29, and thru a Gravity Arm Shaft Bearing 58. The Gravity Arm Shaft Bearing 58 is a standard commercially available bearing with suitable dimensions to accept the Gravity Arm Shaft 57 and fit inside the bottom of the Crown Plate Shaft 29. A Gravity Arm Shaft Collar 59 consisting of a commercially available shaft collar, is attached to the Gravity Arm Shaft 57 below the Gravity Arm Shaft Bearing 58.

A Gravity Arm Arch 60 is an arch shaped structure, such as a tube or rod of predetermined diameter, bent in the shape of an arch or other suitable shape, of a predetermined height and width, having two straight ends of predetermined length. One end is attached to the flat surface on the Gravity Arm Hub 56 via welded connection or other acceptable means. The Gravity Arm Arch 60 is formed to an approximate angle equal to that of the Counterweight Arms 31. The Gravity Arm Arch 60 is connected to a Gravity Arm 61, via a welded or other suitable connection. A Gravity Arm 61 is a straight rod or tube of a predetermined length and diameter, extending thru the center bore of a Gravity Arm Weight 62 and is secured by a Gravity Weight Stay Bolt 63 via a lateral hole in both the Gravity Arm Weight 62 and the Gravity Arm 61 at an appropriate location. A Gravity Arm Weight 62 is a weight of a predetermined mass, of a cylindrical shape or other suitable shape, and has a center bore spanning the longitudinal axis, constructed of high-density material such as cast iron or any other suitable material. Shown in FIG. 5.

Attached along the Gravity Arm 61 is a Gravity Arm Torsion Wheel Mount Plate 64 at a suitable location. The Gravity Arm Torsion Wheel Mount Plate 64 is a rectangular carbon steel plate of a predetermined thickness and dimension, attached via welds or other suitable means, perpendicularly along the Gravity Arm 61 at a proper location, extending lengthwise towards the Conic Counterweight Arm Assembly 30. A hole is cut into the Gravity Arm Torsion Wheel Mount Plate 64 at a appropriate location to accept a Torsion Wheel Axle 52. A Torsion Wheel Axle 52 is a short shaft of a predetermined length and diameter. A Torsion Wheel 53 is mounted on the Torsion Wheel Axle 52 and secured with a standard Shaft Collar 54. The Torsion Wheel 53 sets on and runs along a Torsion Wheel Track 36. A Torsion Wheel Track 36 is a circular band of suitable size and material, that is attached to the Counterweight Arms 31 via welds or other means, and forms a circular track around the circumference of the Conic Counterweight Arm Assembly 30. Shown in FIG. 5 an FIG. 7.

A Main Shaft Assembly 65 consists of a Main Shaft 66, a Flexible Shaft Coupler 67, a Upper Shaft Bearing 68, Upper Shaft Collar 69, Lower Shaft Bearing 70, Lower Shaft Collar 71. Shown in FIG. 6.

A Main Shaft 66 consisting of a rod of appropriate length and diameter, is attached via suitable means to a Flexible Shaft Coupler 67. The Flexible Shaft Coupler 67 consists of a commercially available flexible shaft coupler that allows for non-parallel transmission of rotational energy. The Gravity Arm Shaft 57 is attached via suitable means to the opposite end of the Flexible Shaft Coupler 67. The Flexible Shaft Coupler 67 is located at or nearest the center of rotation of the Gimbal assembly 20 within the center of the Inner Gimbal Plate 21 and within the center of the Mast Collar 18. Shown in FIG. 8.

A Upper Shaft Bearing 68 is set within the center hole of the Mast Collar 18 and accepts the Main Shaft 66. A Lower Shaft Bearing 70 is set within the center hole of the Upper Divide Plate 16 and accepts the Main Shaft 66. Both the Upper Shaft Bearing 68 and the Lower Shaft Bearing 70 are commercially available bearings of a proper size and dimension to accept the Main Shaft 66 and fit each respective center hole. A Upper Shaft Collar 69 is attached above the Upper Shaft Bearing 68 along the Main Shaft 66, and the Lower Shaft Collar 71 is located below the Lower Shaft Bearing 69 along the Main Shaft 66. Both the Upper Shaft Collar 69 and the Lower Shaft Collar 71 are commercially available shaft collars of a proper size and dimension to accept the Main Shaft 66. Shown in FIG. 6.

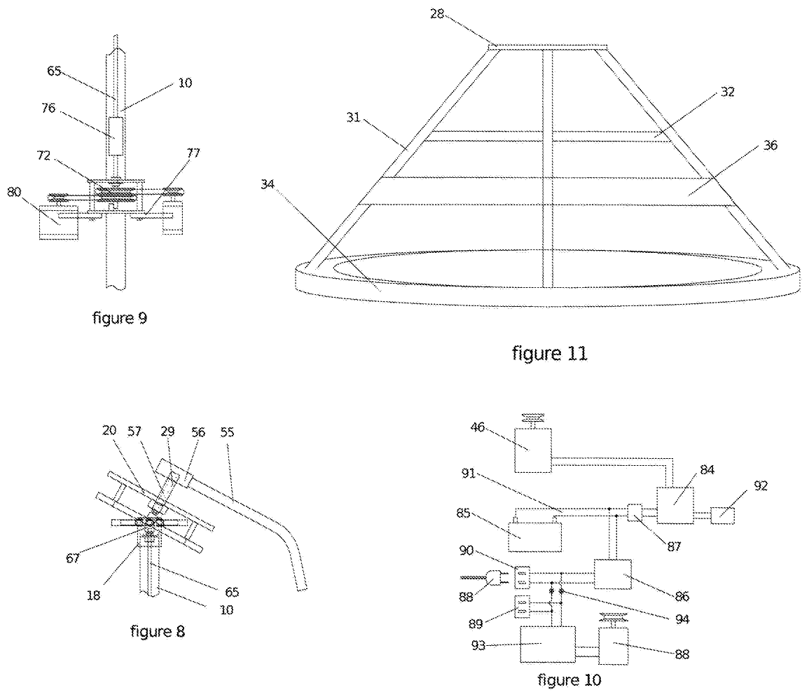

A Transmission Assembly 72 consists of a Transmission Pulley 73, a series of Transmission Belts 74, a series of Transmission Pulleys 75, Electric Clutch Mechanism 76. Shown in FIG. 6, FIG. 7, and FIG. 9.

A Transmission Pulley 73 is attached to the lower end of the Main Shaft 66 via a set screw or other suitable means. The Transmission Pulley 73 is commercially available pulley of a suitable diameter and type, and accepts a Transmission Belt 74. A Transmission Belt 74 is a commercially available belt, made of a suitable material, sized to fit the Transmission Pulley 73 and connect to a Transmission Pulley 75 connected to the shaft of a Rotary Power Generating Device 80. Additionally, a commercially available Electrical Clutch Mechanism 76 can be connected to the Main Shaft 66 where the Transmission Pulley 73 connects and thus the Transmission Pulley 73 would connect to the output shaft of the Electrical Clutch Mechanism 76 by suitable means. Shown in FIG. 9.

A Attachment Mounting Assembly 77 consists of a Attachment Mounting Bracket 78, a series of Attachment Mounting Bolts 79, a Rotary Power Generating Device 80, a Alternator 81, a Fluid Pump 82. Shown in FIG. 6, FIG. 7, and FIG. 9.

A Attachment Mounting Bracket 78, is a specialized bracket designed to fit various types of a Rotary Power Generating Device 80. The Attachment Mounting Bracket 78 consists of a steel bracket bent to fit the mounting holes of a commercially available Alternator 81, or the mounting holes of a commercially available Fluid Pump 82 when either of these components are used as a Rotary Power Generating Device 80. The Attachment Mounting Bracket is attached to the Lower Divide Plate 14 via a series of Attachment Mounting Bolts 79 or other suitable means. Shown in FIG. 6.

A Electrical Control Assembly 83 consists of a Motor Control Circuit 84, a Motor Start-Up Battery 85, a Charge Controller 86, a Input Power Voltage Regulator 87, a External Power Source 88, a Output Power Receptacle 89, a Input Power Receptacle 90, a series of Electrical Connection Wires 91, a Sensor 92, a Power Inverter 93, a Diode 94. Shown in FIG. 6, FIG. 7 and FIG. 10.

A Drive Motor 46 is electrically connected to a Motor Control Circuit 84. All electrical connections are via a series of Electrical Connection Wires 91 of proper gauge. Motor Control Circuit 84, is a commercially available programmable motor controller that delivers power to Drive Motor 46, and connects to a Sensor 92, and Input Power Voltage Regulator 87. Sensor 92 is a magnetic rpm sensor that determines rpm of Main Shaft 66 to allow Motor Control Circuit 84 to adjust electrical power to Drive Motor 46 accordingly. A Input Power Voltage Regulator 87 is a commercially available voltage regulating circuit that conditions electrical power to meet the power input requirements of Motor Control Circuit 84.

A Motor Start-Up Battery 85 is connected in parallel to the Input Power Voltage Regulator 87 and to a commercially available Charge Controller 86. A Motor Start-Up Battery 85 is a commercially available battery that meets the combined power requirements of Motor Control Circuit 84 and Drive Motor 46 and provides power during start up. The Charge Controller 86 is connected in parallel to a commercially available Power Inverter 93 output via a series of Diodes 94, and to connected to a plug-type Input Power Receptacle 90. Shown in FIG. 10.

A Input Power Receptacle 90 is attached to a External Power Source 88 when using a non-electrical Rotary Power Generating Device 80 such as a commercially available Fluid Pump 82 attachment only. A plug-type Output Power Receptacle 89 is connected to the Power Inverter 93 output. The Power Inverter 93 input is connected to a commercially available alternator 81 attachment output leads. Shown in FIG. 10.

The present invention may be embodied in other specific forms without departing from the essential attributes thereof. Reference should be made to the appending claims rather than the foregoing specification as indicating the scope of the invention.

### Operation—FIGS. 6, 7, 8, 10

The main embodiment of the present invention is designed to provide for a means to eliminate the production of unwanted motions of a potential energy to rotational acceleration mechanism due to gyroscopic forces from the rotary power generating device reacting to an outside acceleration field, such as a gravitational field. Such forces can create perturbations in the movements of the arm assemblies and reduce efficiency.

It is also important to note, that the higher the angular speed of the rotary power generating device, the more gyroscopic force is generated by the rotating components. This translates into a increased perturbations in the movements of the mechanism and a loss of efficiency. This also limits the rotational speed of the rotary power generating device to lower angular speeds to avoid buildup of gyroscopic force.

The Rotary Power Generating Device 80 is mounted to an improved Tower Mount Assembly 10, underneath the rotational center of the Gimbal Assembly 20, thus allowing for the stationary mounting of the Rotary Power Generating Device 80 and proper support of the mechanism. The Tower Mount Assembly 10 has an opening in its design to allow the main shaft to connect to a Transmission Assembly 72. Power is transmitted to a now stationary, Rotary Power Generating Device 80 that is mounted to the Lower Divide Plate 14 of the Tower Mount Assembly 10, via a Attachment Mounting Assembly 77. Shown in FIG. 6 and FIG. 7.

A Flexible Shaft Coupler 67, or other suitable means, is added to the Main Shaft Assembly 65 to allow the Gravity Arm Assembly 55 of the mechanism to drive the Main Shaft Assembly 65 and Transmission Assembly 72 connecting the stationary Rotary Power Generating Device 80 while allowing for the constantly changing angle of the Gimbal Assembly 20. A Crown Plate 28 is added above and connected to the outer Gimbal Plate 24 of the Gimbal Assembly 20 and supports the Gravity Arm Assembly 55, the Action Arm Assembly 37, and Drive Motor 46. A Crown Plate Shaft 29 is used to add support for the Action Arm Assembly 37 and the Gravity Arm Assembly 55 to compensate for increased arm weights and arm speed that increase torsional stress on the hubs. Shown in FIG. 7 and detailed in FIG. 8.

An improved Conic Counterweight Arm Assembly 30 is necessary due to the location of the Tower Mount assembly 10 and associated Rotary Power Generating Device 80. A series of outwardly angled Counterweight Arms 31 and Arm Supports 32 with a Ring Shaped Counterweight 34, or a series of individual Counterweights 33 create a conic, or bell-shaped Arm Assembly 30, and creates a void directly underneath the Gimbal Assembly 20 that accommodates the position of the Tower Mount Assembly 10 and Stationary Rotary Power Generating device 80. This Conic Counterweight Arm Assembly 30 is attached to the Outer Gimbal Plate 24 of the Gimbal Assembly 20. The Conic shape also provides a means to support a Torsion Wheel Track 36 for the arm Torsion Wheels 53 to ride on. This feature reduce the torsional stress applied the Arm Hubs 38 and 56, and allows for the use of larger Arm Weights 44 and 62, thus increase power output. Shown in FIG. 7.

The improved Gimbal Assembly 20 has the Inner Gimbal Plate 21 attached rotationally to the Tower Mount assembly 10 via the Mast Collar 18. The Inner Gimbal Plate 21 is attached rotationally to the Outer Gimbal Plate 24. The Outer Gimbal Plate 24 is rigidly attached to the crown plate 28. The conic counterweight arm assembly 30 is rigidly attached to the crown plate 28. Shown in FIG. 8.

The improved Gravity Arm assembly 55 and Action Arm Assembly 37, and the addition of Torsion Wheels 53 at the arm ends, will allow for the use of heavier Arm Weights 44 and 62, while reducing unwanted torsional shear at the Arm Hubs 38 and 56. The Action Arm Assembly 37 and Gravity Arm Assembly 55 angle downward at or near the same angle as the Conical Counterweight Arm Assembly 30. Torsion Wheels 53 at the end of both arm assemblies run along a circular Torsion Wheel Track 36, mounted to the Conic Counterweight Arm Assembly 30. These arm changes can further reduce the size of the device while allowing for increased arm masses increasing output and improve operation. Shown in FIG. 7.

### Conclusion, Ramifications and Scope

Accordingly the reader will see that the mechanism of this invention provide a means to use an acceleration field to create mechanical advantage in the form of rotational acceleration while eliminating reactant gyroscopic forces generated by the rotating power attachment or rotary power generating device. This allows the device to spin free of unwanted perturbations in the rotational orbits of the moving arm assemblies. Small changes, or perturbations, in the orbits of the arm assemblies, cause the mechanism to become unbalanced and unstable requiring a limiting of angular speed, and change the force vectors that produce the motion thus adding drag to the arm movements. All this adds up to reduce the overall efficiency and safety of the device.

With the improvements of the mechanism implemented, the angular speed can be increased dramatically, increasing the output of the mechanism. The amount of mass of the arm weights can be increased while not adding unwanted torsional stress to the arm hub assemblies via the addition of the torsion wheels to the arm assemblies. Increased mass equals increased arm moments thus increase torque output of the gravity arm.

The conic counterweight arm is key to using a central tower mount. The much simpler central tower mount will not interfere with the rotation of the arms or the swinging of the counterweight arm, thus eliminating the possibility of a mount strike during operation. The conic counterweight arm assembly also shortens the vertical center of gravity thus making the mechanism shorter in height.

The flexible shaft coupler is key to the operation of the device. This simple device allows the transfer of rotational power from the gravity arm thru the moving gimbal assembly, to the main shaft assembly during operation. The main shaft assembly then transfers the rotational power to the transmission and the rotary power generating device.

The improvements to the original device produce a new device that is safer and more efficient to operate. Efficiency is of ultimate importance since the mechanism not only has to provide power for its own sustained motion, but create an excess of power to be available outside the system. As this system is scalable, larger mechanisms are possible to generate large amounts of energy. These larger systems would require weights in the thousands of kilograms and would create certain danger during operation due to the nature of the forces generated, thus safety is certainly of the highest priority and such improvements in design are a necessity.

Although the aforementioned description contains many specificities, these should not be construed as limiting the scope of the invention, but merely providing illustrations of some of the presently preferred embodiments of this invention.

For example, an additional embodiment of the current invention shows the use of a vertical tower mount allows the power attachments to be mounted stationary to the movement of the mechanism and provide a means to attach more than one rotary power generating device. A series of electrical alternators, or a series of fluid pumps, or a mixture of rotary power generating devices, is possible provided the gravity arm moment is sufficient to provide necessary power input. The mechanism can simply be made larger to accommodate this power increase. Shown in FIG. 6 and FIG. 7.

An additional embodiment of the current invention uses a ring-shaped weight instead of individual weights located on the conic counterweight arms. This ring weight is of a mass equal to the total masses of the individual weights. This ring weight would create a balance angle equal to that formed by the individual weight assembly. Shown in FIG. 11.

An additional embodiment of the current invention would have the ring-shaped counterweight have a smooth outer surface so that the torsion wheels of both arms could contact and ride along the periphery of the ring weight. This would eliminate the torsion wheel track and simplify the conic counterweight arm assembly.

An additional embodiment of the current invention attaches an commercially available, electrical clutch assembly to the transmission assembly thus allowing a method to unload the mechanism during start up, or during overload and emergency stop procedures. Shown in FIG. 9.

An additional embodiment would locate the drive motor to the end of the action arm to drive the torsion wheel about the torsion wheel track. While this embodiment would simplify the construction of the action arm drive mechanism, the positioning of a rotating motor at the end of the action arm would create a source of gyroscopic force that could create perturbations at higher angular speeds. Similarly, a rotary power generating device could be attached at the end of the gravity arm assembly but would suffer the same force generation, thus a mechanism with this embodiment would have a limit in angular speed.

An additional embodiment of the current invention would have the arm weights movable along the arms via mechanical means controlled by a logic circuit to allow for on the fly adjustments of the machine parameters thus fine control of the operation of the mechanism.

Thus the scope of the invention should be determined by the appended claims and their legal equivalents, rather than by the given examples.

I claim:

1. A improved mechanism to create rotational mechanical advantage from an acceleration field while eliminating reactant gyroscopic forces, consisting of:
a mount assembly to support said mechanism comprising a collar rotationally connected to said horizontal center axis of said inner plate gimbal, said collar connects to a mast assembly, legs and connected leg support members,
a means to eliminate reactant gyroscopic forces in the form of a stationary mounted rotary power generating device attached to said mount assembly,
a common pivot axis in the form of a gimbal assembly comprised of an inner plate gimbal within an outer plate gimbal, whereas said inner plate gimbal pivots about a horizontal center axis, said outer plate gimbal pivots about a perpendicular horizontal center axis, said inner plate gimbal is rotationally attached to said mount assembly,
a first weighted arm assembly comprised of a series of interconnected angled arms forming a conic shape, of a combined predetermined mass, having a combined center of mass a predetermined distance from a center axis, whereas said first weighted arm assembly rigidly connects vertically to said common pivot axis,
a second weighted arm assembly of a predetermined mass, having a center of mass at a predetermined distance from a center axis, having a means for controlled powered rotation about said center axis, whereas said second weighted arm assembly rotationally connects horizontally to said common pivot axis, adjacent to said second weighted arm assembly, and angles to rotationally contact said first weighted arm assembly via a wheel and track assembly,
a third weighted arm assembly of a predetermined mass, having a center of mass at a predetermined distance from a center axis, whereas said third weighted arm assembly rotationally connects horizontally to said common pivot axis, and angles to rotationally contact said first weighted arm assembly via a wheel and track assembly,
a means of controllably coupling a rotational mechanical advantage of said third weighted arm assembly to a stationary rotary power generating device via a flexible shaft connection centered within rotating axis of said gimbal assembly.

2. The device of claim 1 wherein said mount assembly allows stationary mount of rotary power generating device.

3. The device of claim 1 wherein said first weighted arm assembly has a conic shaped structure of predetermined dimensions.

4. The device of claim 1 wherein said second weighted arm assembly angles to rotationally contact said first weighted arm assembly via a wheel and track assembly of predetermined dimensions.

5. The device of claim 1 wherein said third weighted arm assembly angles to rotationally contact said first weighted arm assembly via a wheel and track assembly of predetermined dimensions.

6. The device of claim 1 wherein said third weighted arm assembly flexibly connects to a shaft assembly via a flexible shaft connection selected from the group consisting of flexible shaft couplings.

7. The device of claim 1 wherein said flexible shaft connection is located at the center of rotation of said gimbal assembly.

8. A improved mechanism to create rotational mechanical advantage from an acceleration field while eliminating reactant gyroscopic forces, consisting of:
a means to pivotally mount and support said mechanism while providing a means to eliminate reactant gyroscopic forces,
at least one, first weighted arm assembly comprised of a series of interconnected angled arms forming a conic shape, of a combined predetermined mass, having a combined center of mass a predetermined distance from a center axis, whereas said first weighted arm assembly rigidly connects vertically to said common pivot axis,
at least one, second weighted arm assembly of a predetermined mass, having a center of mass at a predetermined distance from a center axis, having a means for controlled powered rotation about said center axis, whereas said second weighted arm assembly rotationally connects horizontally to said common pivot axis, adjacent to said second weighted arm assembly, and angles to rotationally contacts said first weighted arm assembly via a wheel and track assembly,
at least one, third weighted arm assembly of a predetermined mass, having a center of mass at a predetermined distance from a center axis, whereas said third weighted arm assembly rotationally connects horizontally to said common pivot axis, and angles to rotationally contact said first weighted arm assembly via a wheel and track assembly,
a means to controllably coupling a rotational mechanical advantage of said third arm via a flexible shaft connection thru a common pivot axis, to a rotary power generating device selected from the group consisting of power generating devices.

9. The device of claim 8 wherein said mount assembly allows stationary mount of rotary power generating device.

10. The device of claim 8 wherein said first weighted arm assembly has a conic shaped structure of predetermined dimensions.

11. The device of claim 8 wherein said second weighted arm assembly angles to rotationally contact said first weighted arm assembly via a wheel and track assembly of predetermined dimensions.

12. The device of claim 8 wherein said third weighted arm assembly angles to rotationally contact said first weighted arm assembly via a wheel and track assembly of predetermined dimensions.

13. The device of claim 8 wherein said third weighted arm assembly flexibly connects to a shaft assembly via a flexible shaft connection selected from the group consisting of flexible shaft couplings.

14. The device of claim 8 wherein said flexible shaft connection is located at the center of rotation of said gimbal assembly.
